(19) United States
(12) Patent Application Publication
(10) Pub. No.: US 2025/0357704 A1
(43) Pub. Date: Nov. 20, 2025

(54) COMPRESSION ATTACHED MEMORY MODULE CONFIGURATION

(71) Applicant: Intel Corporation, Santa Clara, CA (US)

(72) Inventors: Landon HANKS, Milwaukie, OR (US); Xiang LI, Portland, OR (US)

(21) Appl. No.: 19/287,947

(22) Filed: Aug. 1, 2025

(51) Int. Cl. H01R 13/6461; H01R 13/11

(52) U.S. Cl. CPC H01R 13/6461; H01R 13/11

(57) ABSTRACT

Disclosed herein is a compression mount connector for a memory module with an additional cluster of pins between the typical two clusters of pins. The pins of the third cluster include a first subset of pins and a second subset of pins, wherein each pin of the first subset form a partially enclosed shape (e.g., a C-shape) that opens along a direction that is oblique to the direction of the first and second pins. Each pin of the second subset also forms a partially enclosed shape that opens in a direction that is opposite to the direction of the pins of the first subset.

### BACKGROUND

Modern computing systems demand increasingly higher data transfer rates, placing greater performance and signal integrity requirements on memory module connectors. As signaling frequencies increase, conventional connector architectures face challenges such as signal degradation, cross talk, and electromagnetic interference, especially from neighboring power and ground lines. These impacts may limit performance and scalability while simultaneously complicating efforts to minimize board footprint.

Compression Attached Memory Module (CAMM) connectors often employ “C”-shaped pins arranged in clusters (e.g., signal, power, ground), typically divided across two halves of the connector housing. To manage mechanical stress, the pins are oriented such that the open ends face outward-right-facing on the right half and left-facing on the left half-thereby balancing lateral forces. However, this standard configuration may face limitations at higher data rates due to proximity effects and insufficient isolation between signal and power paths.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows a side view of an example cluster of three C-shaped pins of a typical CAMM;

FIG. 2 illustrates a perspective view of an example cluster of three C-shaped pins of a typical CAMM;

FIG. 3 depicts a top view of two clusters of C-shaped pins of a typical CAMM;

FIG. 4 shows a top view of a portion of a connecter, where there is a third cluster of C-shaped pins between and orthogonal to the other clusters of pins; and

FIG. 5 illustrates a perspective view of an example portion of a connector, where there is a third cluster of C-shaped pins between and orthogonal to the other clusters of pins.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc., where “[ . . . ]” means that such a series may continue to any higher number). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc., where “[ . . . ]” means that such a series may continue to any higher number).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc., or any combination thereof.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

As noted above, a typical compression connector, such as a compression attached memory module (CAMM), has pins arranged in clusters (e.g., signal, power, ground), typically divided across two halves of the connector housing. To manage mechanical stress, the pins are oriented such that the open ends face outward-right-facing on the right half and left-facing on the left half-thereby balancing lateral forces. However, this standard configuration may face limitations at higher data rates due to proximity effects and insufficient isolation between signal and power paths. Disclosed in more detail below is a connector that includes an area of additional pins that are oblique to (e.g., orthogonal to) the orientation of the pins in the left- and right areas. This area of additional pins may help improve mechanical balance and may also improve the electrical performance at high signal speeds. The disclosed connector may help mitigate signal cross talk, improve impedance control, and enable compact, high-density pin configurations while minimizing lateral force on the connector housing.

The connector may include a housing having a surface from which multiple clusters of pins extend outward. A first cluster of pins is positioned along one side of the connector body (e.g., on a “right” side of the surface of the connector when viewed from the top). Each pin in this first cluster may form a partially enclosed shape, such as a “C”-shaped form, with the open portion of the shape oriented in a first direction, e.g., towards the right. A second cluster of pins may be positioned on the opposite side of the connector housing (e.g., on the “left” side of the surface of the connector when viewed from the top). Similar to the first cluster, each pin in the second cluster forms a partially enclosed shape. However, the pins in the second cluster open in a second direction that is opposite to the first direction—e.g., towards the left and 180 degrees from the opening right. This mirrored arrangement of pin orientations across the connector housing helps cancel lateral forces that would otherwise result from asymmetric pin compression.

Disposed on the surface of the connector housing between the first and second clusters is a third cluster of pins, located centrally along the axis formed between the. The third cluster is divided into two subsets of pins, each pin having a partially-enclosed shape. Each pin in the first subset opens in a direction opposite to the pins in the second subset. In addition, the pins in the third cluster open at an oblique angle to both the first and second directions (e.g., orthogonal to the axis along which the opening of the right/left clusters are oriented). Each pin in a second subset forms a similar shape opening in a fourth direction, opposite to the third direction (e.g., rotated 180 degrees from the third direction).

In some embodiments, the third and fourth directions are orthogonal to the first and second directions, such that the middle pins open either “up” or “down” along a vertical axis relative to the lateral arrangement of the outer clusters. This provides a more balanced stress distribution across the connector, allowing for higher pin density while also enabling greater spatial separation of critical signals, power lines, and grounding paths.

The third cluster may be arranged along a central axis defined between the first and second clusters or may be offset along a perpendicular axis. In certain embodiments, the pins of the first and second subsets within the third cluster are arranged in distinct matrix regions (e.g., adjacent rectangular arrays). In some embodiments, the pins of the two subsets (with pins of opposite orientations) are interspersed within a single matrix region, either randomly or according to a predetermined pattern (e.g., alternating by row, column, or checkerboard layout). This flexibility in layout supports optimization for specific signal integrity or routing needs.

The third cluster may include a mix of signal pins, power pins, and ground pins. In various embodiments, the outer perimeter of the matrix may include ground pins to provide shielding and reference continuity for surrounding signal lines. The number of pins in the third cluster may vary depending on system requirements and the number of pins in the first and second clusters. For example, the first and second clusters may each include 210 pins, while the third (middle) cluster may include 60 pins. As should be appreciated, each cluster may have any number of pins. Additionally, the spacing or pitch between adjacent pins may vary across clusters. For instance, the pitch within the third cluster may be smaller than that of the first and second clusters to support higher pin density or finer routing. These pitch variations may be oriented along the same axis or a perpendicular axis relative to the direction defined by the first and second clusters. Although the examples described herein are in the context of a memory module compression mount connector, the disclosed pin configuration may also be applied to other high-speed, high-density electrical interfaces where signal integrity and mechanical balance are important.

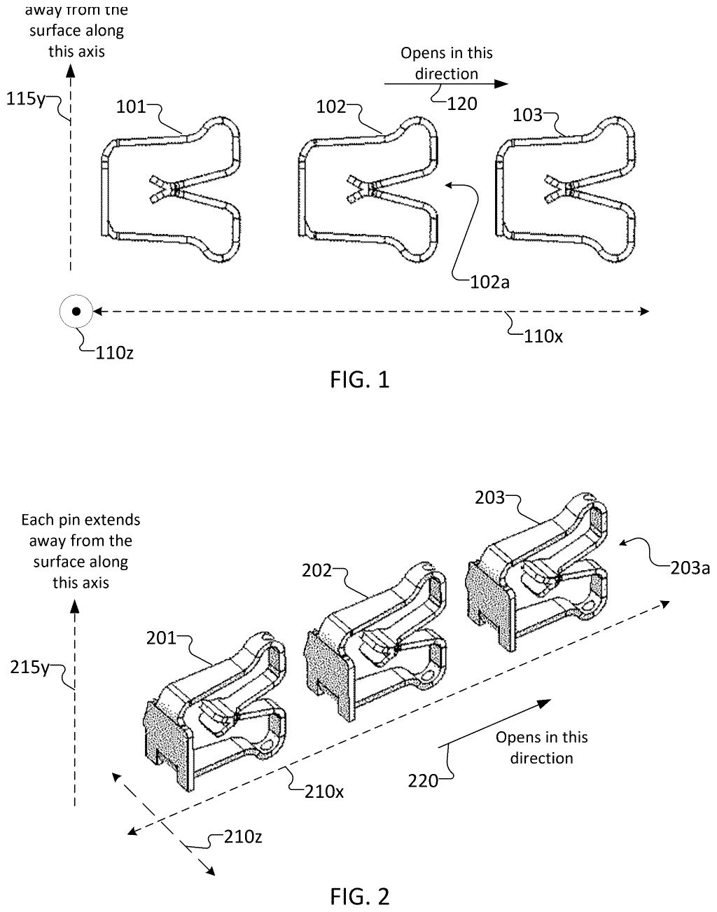

FIG. 1 shows a side view of three C-shaped pins that are typically used in CAMMs. Pin 101, pin 102, and pin 103 each form a partially enclosed shape, a “C”-shaped form, where one side of the pin has an opening to receive a connecting pin. This opening is labeled on pin 102 as opening 102a. Opening 102a, and the openings of pin 101 and pin 103, each face toward the right (shown by arrow 120) along axis 110x, along which the pins 101, 102, and 103 are also distributed. The view of pins 101, 102, and 103 is a side view, where the pins are mounted on a surface defined along axis 110x (left/right on the page) and axis 110z (into/out of the page). The pins 101, 102, and 103 extend away from the surface along axis 115y (up/down on the page). While only three pins are shown for simplicity, a connector may have any number of pins. In addition, while not shown, the surface from which pins 101, 102, and 103 extend may be a housing, printed circuit board, or other type of framework for holding the pins and allowing them to connect to signal, power, ground, and/or other types of data lines.

FIG. 2 shows a perspective view of the three C-shaped pins of FIG. 1. Pin 201, pin 202, and pin 203 each form a partially enclosed shape, a “C”-shaped form, where one side of the pin has an opening to receive a connecting pin. This opening is labeled on pin 203 as opening 203a. Opening 203a, and the openings of pin 201 and pin 202, each face toward the upper right (shown by arrow 220) along axis 210x, along which the pins 201, 202, and 203 are also distributed. The view of pins 201, 202, and 203 is a perspective view, where the pins are mounted on a surface defined along axis 210x and axis 210z. The pins 201, 202, and 203 extend away from the surface along axis 215y. While only three pins are shown for simplicity, a connector may have any number of pins. As with FIG. 1, while not shown, the surface from which pins 201, 202, and 203 extend may be a housing, printed circuit board, or other type of framework for holding the pins and allowing them to connect to signal, power, ground, and/or other types of data lines.

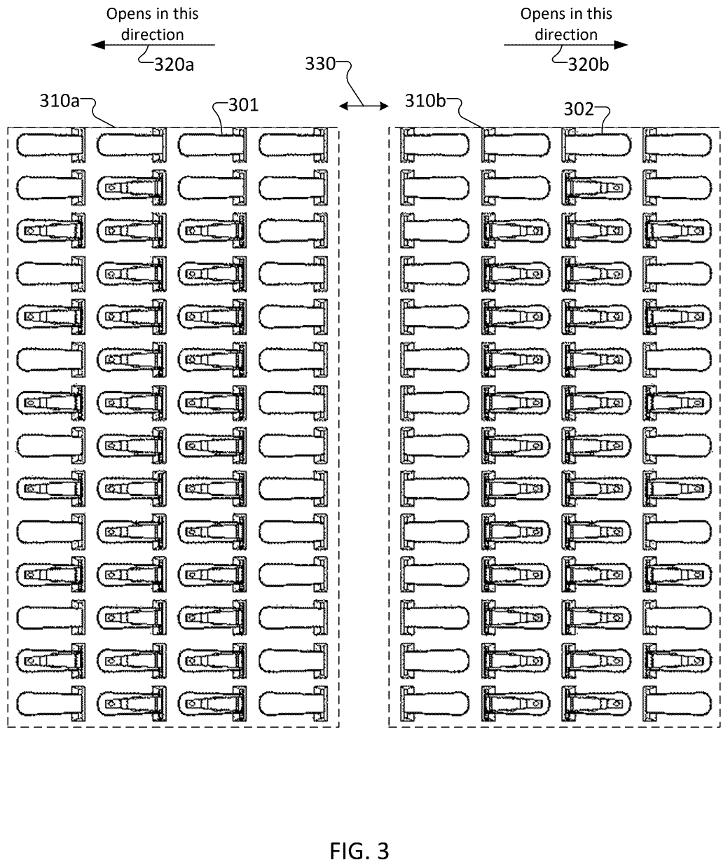

FIG. 3 shows a top view of two clusters of pins of a typical CAMM, where a first cluster 310a has pins whose openings face to the left (e.g., see example pin 301) and a second cluster 310b has pins whose openings face to the right (e.g., see example pin 302). The pins in each of the clusters 310a and 310b may be the C-shaped type of pins shown in FIG. 1 and FIG. 2, where the opening of the partially enclosed shape of each pin in cluster 310a faces in a direction that is opposite to the opening of each pin in cluster 310b. As depicted in FIG. 3, cluster 310a has pins that open toward the left (along arrow 320a) and cluster 310b has pins that open toward the right (along arrow 320b). As shown in FIG. 3, the pins in each cluster are arranged in a matrix (4 pins by 14 pins in each cluster, for a total of 56 pins in each cluster) on the surface, were each pin extends away from the surface (e.g., out of the page in the view of FIG. 3). While only 56 pins are shown in each cluster, it should be understood that any number of pins may be in each cluster, with preferably the same number of pins in each cluster so as to balance the insertion forces when connecting a device to the module. In a typical CAMM, the two clusters may be physically separated by a spacing, as indicated by, for example, space 330 in FIG. 3.

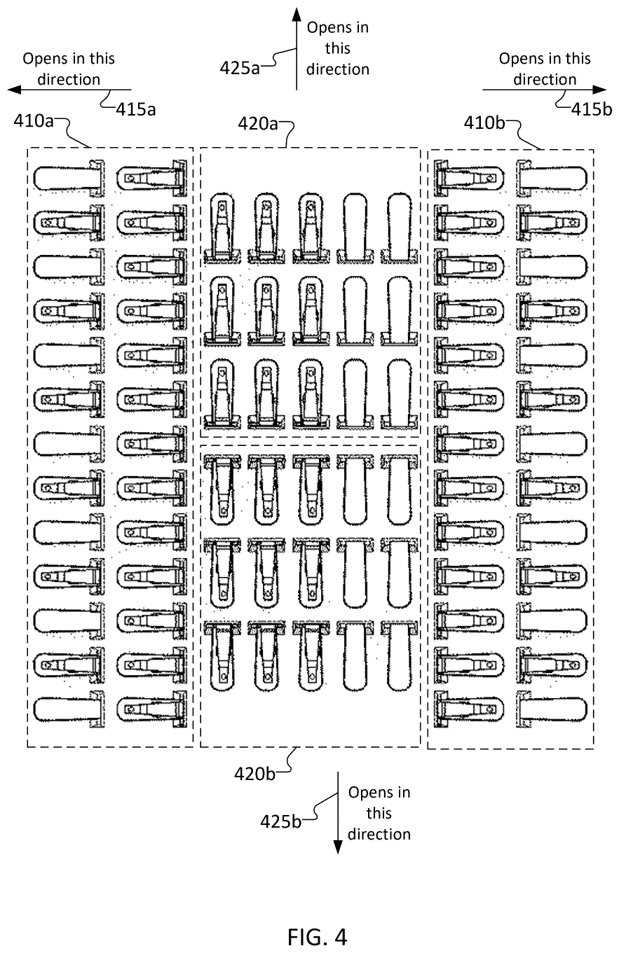

FIG. 4 shows a top view of an example portion of an improved connector, where there is a third cluster of pins (defined by upper subset 420a and lower subset 420b) between the left side cluster 410a and the right side cluster 410b. The opening of the pins in the third cluster are rotated at an oblique angle to the openings of the pins in the first and second cluster. In the example of FIG. 4, the opening of the pins in the third cluster are orthogonal to (e.g., rotated by 90 degrees) with respect to the opening of the pins in the first and second cluster. As depicted in FIG. 4, the pins in the left side cluster 410a open in a direction indicated by arrow 415a that is opposite to (e.g., 180 degrees to) the openings of the pins in the right side cluster 410b, which open in direction indicated by arrow 415b.

In a similar manner, the third cluster has pins in the upper subset 420a that open in a direction indicated by arrow 425a that is opposite to (180 degrees to) the openings of the pins that are in in the lower subset 420b indicated by arrow 425b. With respect to the pins in the left side cluster 410a and right side cluster 410b, the pins in the third cluster open in a direction that is at an oblique angle- and in the example of FIG. 4, orthogonal (90 degrees)—to the directions in which the pins in the left and right side clusters (410a, 410b) open. An advantage of the oblique angle for the third cluster is that such an orientation with respect to the left and right side clusters (410a, 410b) allows for a greater density of pins in the central part of the connector, without the need for a space between the left side cluster 410a and the right side cluster 410b. For example, the third cluster may have ground pins at the outermost columns (and/or outermost rows) with power pins in the inner columns so as to separate signal pins (that may be at the edges of clusters 410a, 410b) from the power pins. With a ground pin column/row separating the power pins from the signal pins, the connector may reduce the impact to far end cross talk (FEXT) and near end cross talk (NEXT). While such a pin configuration may be particularly beneficial for reducing cross talk, it should be understood that any type of pin configuration may be used, depending on the needs of the connector.

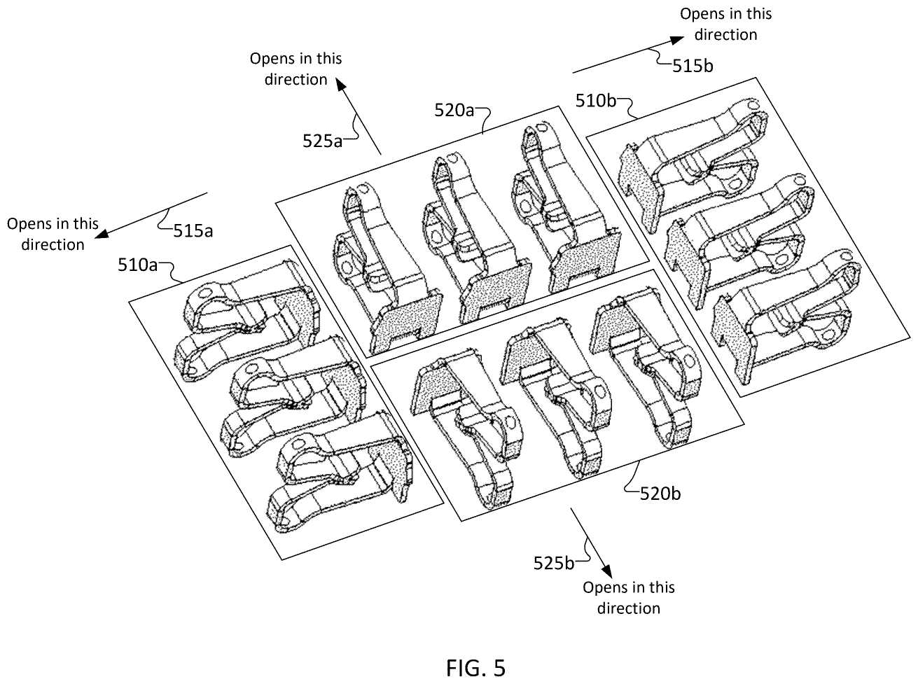

FIG. 5 shows a perspective view of an example portion of an improved connector, where there is a third cluster of pins (defined by upper subset 520a and lower subset 520b) between the left side cluster 510a and the right side cluster 510b. The opening of the pins in the third cluster are rotated at an oblique angle to the openings of the pins in the first and second cluster. In the example of FIG. 5, the opening of the pins in the third cluster are orthogonal to (e.g., rotated by 90 degrees) with respect to the opening of the pins in the first and second cluster (left side cluster 510a and right side cluster 510b). As depicted in FIG. 5, the pins in the left side cluster 510a open in a direction indicated by arrow 515a that is opposite to (e.g., 180 degrees to) the openings of the pins in the right side cluster 510b, which open in direction indicated by arrow 515b. In a similar manner, the third cluster has pins in the upper subset 520a that open in a direction indicated by arrow 525a that is opposite to (180 degrees to) the openings of the pins that are in in the lower subset 520b indicated by arrow 525b. With respect to the pins in the left side cluster 510a and right side cluster 510b, the pins in the third cluster open in a direction that is at an oblique angle- and in the example of FIG. 5, orthogonal (90 degrees)—to the directions in which the pins in the left and right side clusters (510a, 510b) open. An advantage of the oblique angle for the third cluster is that such an orientation with respect to the left and right side clusters (510a, 510b) allows for a greater density of pins in the central part of the connector, without the need for a space between the left side cluster 510a and the right side cluster 510b. For example, the third cluster may have ground pins at the outermost columns (and/or outermost rows) with power pins in the inner columns so as to separate signal pins (that may be at the edges of clusters 510a, 510b) from the power pins. With a ground pin column/row separating the power pins from the signal pins, the connector may reduce the impact to FEXT and NEXT. While such a pin configuration may be particularly beneficial for reducing cross talk, it should be understood that any type of pin configuration may be used, depending on the needs of the connector.

In the following, various examples are provided that may include one or more aspects described with reference to the connector configurations discussed above and/or any of FIGS. 1-5.
Example 1 is a device (e.g., a compression mount connector for a memory module) that includes a first cluster of pins (e.g., on the “right” side of the connector body/housing) extending outward from a surface, each pin forming a partially enclosed shape that opens in a first direction (e.g., towards the right) along the surface. The device also includes a second cluster of pins (e.g., on the “left” side) extending outward from the surface, each pin forming a partially enclosed shape that opens in a second direction (e.g., towards the left) along the surface, wherein the second direction is opposite to the first lateral direction (e.g., so as to cancel lateral force). The device also includes a third cluster of pins (e.g., the new “middle” section of pins) positioned along the surface between the first cluster and the second cluster, wherein the pins of the third cluster include a first subset of pins and a second subset of pins, wherein each pin of the first subset form a partially enclosed shape (e.g., a C-shape) that opens along a third direction that is oblique to the first and second directions, wherein each pin of the second subset form a partially enclosed shape that opens along a fourth direction that is opposite to the third direction.
Example 2 is the device of example 1, wherein the partially enclosed shapes include C-shapes.
Example 3 is the device of any one of examples 1 to 2, wherein the third direction is orthogonal to the first direction.
Example 4 is the device of example 3, wherein the fourth direction is orthogonal to the second direction.
Example 5 is the device of any one of examples 1 to 4, wherein the second direction is 180 degrees from the first direction.
Example 6 is the device of any one of examples 1 to 5, wherein the fourth direction is 180 degrees from the third direction.
Example 7 is the device of any one of examples 1 to 6, wherein the third cluster of pins is positioned along an axis defined by the first direction and the second direction.
Example 8 is the device of example 7, wherein the first subset and second subset are positioned along the axis.
Example 9 is the device of example 7, wherein the first subset and second subset are positioned along a second axis that is orthogonal to the axis.
Example 10 is the device of any one of examples 1 to 9, wherein the pins of the first subset are arranged in a first matrix region of the surface and the pins of the second subset are arranged in a second matrix region of the surface, wherein the first matrix region is adjacent to the second matrix region.
Example 11 is the device of any one of examples 1 to 10, wherein the pins of the first subset are interspersed with the pins of the second subset to form a common matrix region on the surface.
Example 12 is the device of example 11, wherein the pins of the first subset are interspersed randomly with the pins of the second subset.
Example 13 is the device of example 11, wherein the pins of the first subset are interspersed a predetermined pattern with respect to the pins of the second subset.
Example 14 is the device of example 13, wherein the predetermined pattern alternates by rows or columns in the common matrix region.
Example 15 is the device of any one of examples 1 to 14, wherein the count of pins in the first subset equals the count of pins in the second subset.
Example 16 is the device of any one of examples 1 to 15, wherein the pins in the first subset and in the second subset include a matrix of columns and rows of power pins, ground pins, and/or signal pins.
Example 17 is the device of example 16, wherein an outer perimeter of the matrix includes the ground pins.
Example 18 is the device of any one of examples 1 to 17, wherein adjacent pins of the first and second clusters are spaced apart with a first pitch, wherein adjacent pins of the third cluster are spaced apart with a second pitch that is different from the first pitch.
Example 19 is the device of example 18, wherein the second pitch is smaller than the first pitch.
Example 20 is the device of example 19, wherein the second pitch and the first pitch are horizontal pitches and/or vertical pitches.
Example 21 is the device of example 18, wherein the first and second pitches are in a same direction with respect to an axis defined by the first and second directions.
Example 22 is the device of example 18, wherein the first and second pitches are in an orthogonal direction with respect to an axis defined by the first and second directions.
Example 23 is the device of any one of examples 1 to 22, wherein each of the first cluster and the second cluster together include 260 pins, wherein the third cluster includes 60 pins.
Example 24 is the device of any one of examples 1 to 23, wherein the device includes a compression mount connector for a memory module.
Example 25 is the device of any one of examples 1 to 24, wherein the oblique angle is configured to reduce far end crosstalk and/or near end cross talk between pins of the first, second, and third clusters.
Example 26 is a computing device (e.g., a laptop) that includes a chassis having a mounting region configured to receive a memory module. The computing device also includes a compression mount connector secured to the mounting region. The compression mount connector includes a first cluster of contact pins arranged on a first side of a contact surface of the compression mount connector, the contact pins forming partially enclosed shapes that open in a first lateral direction along the contact surface. The compression mount connector also includes a second cluster of contact pins arranged on a second side of the contact surface opposite the first side, the contact pins forming partially enclosed shapes that open in a second lateral direction opposite to the first direction. The compression mount connector also includes a third cluster of contact pins positioned between the first and second clusters, the third cluster including a first subset of pins and a second subset of pins, wherein each pin of the first and second subsets is a partially enclosed shape that opens in an oblique direction with respect to the first and second clusters, wherein the oblique direction of the first subset is opposite to the oblique direction of the second subset. The computing device further includes a memory module configured to compressively engage with the compression mount connector, wherein the opposite oblique directions of the partially enclosed shapes of the third cluster are configured to counteract forces from compressive engagement between the memory module and the compression mount connector.
Example 27 is the computing device of example 26, wherein the partially enclosed shapes include C-shapes.
Example 28 is the computing device of any one of examples 26 to 27, wherein the oblique direction of the partially enclosed shapes of the first subset is orthogonal to the first lateral direction.
Example 29 is the computing device of example 28, wherein the oblique direction of the partially enclosed shapes of the second subset is orthogonal to the second lateral direction.
Example 30 is the computing device of any one of examples 26 to 29, wherein the second lateral direction is 180 degrees from the first lateral direction.
Example 31 is the computing device of any one of examples 26 to 30, wherein the opposite oblique directions of the partially enclosed shapes of the third cluster are 180 degrees apart.
Example 32 is the computing device of any one of examples 26 to 31, wherein the third cluster of contact pins is positioned along an axis defined by the first lateral direction and the second lateral direction.
Example 33 is the computing device of example 32, wherein the first subset and the second subset of the third cluster are positioned along the axis.
Example 34 is the computing device of example 32, wherein the first subset and the second subset of the third cluster are positioned along a second axis that is orthogonal to the axis.
Example 35 is the computing device of any one of examples 26 to 34, wherein the contact pins of the first subset are arranged in a first matrix region of the contact surface and the contact pins of the second subset are arranged in a second matrix region of the contact surface, wherein the first matrix region is adjacent to the second matrix region.
Example 36 is the computing device of any one of examples 26 to 35, wherein the contact pins of the first subset are interspersed with the contact pins of the second subset to form a common matrix region on the contact surface.
Example 37 is the computing device of example 36, wherein the contact pins of the first subset are interspersed randomly with the contact pins of the second subset.
Example 38 is the computing device of example 36, wherein the contact pins of the first subset are interspersed in a predetermined pattern with respect to the contact pins of the second subset.
Example 39 is the computing device of example 38, wherein the predetermined pattern alternates by rows or columns in the common matrix region.
Example 40 is the computing device of any one of examples 26 to 39, wherein a count of the contact pins in the first subset equals a count of the contact pins in the second subset.
Example 41 is the computing device of any one of examples 26 to 40, wherein the contact pins in the first subset and the second subset include a matrix of columns and rows of power pins, ground pins, and/or signal pins.
Example 42 is the computing device of example 41, wherein an outer perimeter of the matrix includes the ground pins.
Example 43 is the computing device of any one of examples 26 to 42, wherein adjacent contact pins of the first cluster and the second cluster are spaced apart with a first pitch, and adjacent contact pins of the third cluster are spaced apart with a second pitch that is different from the first pitch.
Example 44 is the computing device of example 43, wherein the second pitch is smaller than the first pitch.
Example 45 is the computing device of example 44, wherein the second pitch and the first pitch are horizontal pitches and/or vertical pitches.
Example 46 is the computing device of example 43, wherein the first and second pitches are in a same direction with respect to an axis defined by the first lateral direction and the second lateral direction.
Example 47 is the computing device of example 43, wherein the first pitch and the second pitch are in a direction orthogonal to an axis defined by the first lateral direction and the second lateral direction.
Example 48 is the computing device of any one of examples 26 to 47, wherein each of the first cluster and the second cluster together include 260 pins, wherein the third cluster includes 60 pins.
Example 49 is the computing device of any one of examples 26 to 48, wherein the oblique angle is configured to reduce far end crosstalk and/or near end cross talk between pins of the first, second, and third clusters.
Example 50 is a system that includes a memory module and a compression mount connector configured to receive the memory module. The compression mount connector includes a first cluster of contact pins arranged on a first side of a contact surface of the compression mount connector, the contact pins forming partially enclosed shapes that open in a first lateral direction along the contact surface. The compression mount connector also includes a second cluster of contact pins arranged on a second side of the contact surface opposite the first side, the contact pins forming partially enclosed shapes that open in a second lateral direction opposite to the first direction. The compression mount connector also includes a third cluster of contact pins positioned between the first and second clusters, the third cluster including a first subset of pins and a second subset of pins, wherein each pin of the first and second subsets is a partially enclosed shape that opens in an oblique direction with respect to the first and second clusters, wherein the oblique direction of the first subset is opposite to the oblique direction of the second subset, wherein the opposite oblique directions of the partially enclosed shapes of the third cluster are configured to counteract forces from compressive engagement between the memory module and the compression mount connector.
Example 51 is the system of example 50, wherein the partially enclosed shapes include C-shapes.
Example 52 is the system of any one of examples 50 to 51, wherein the oblique direction of the partially enclosed shapes of the first subset is orthogonal to the first lateral direction.
Example 53 is the system of example 52, wherein the oblique direction of the partially enclosed shapes of the second subset is orthogonal to the second lateral direction.
Example 54 is the system of any one of examples 50 to 53, wherein the second lateral direction is 180 degrees from the first lateral direction.
Example 55 is the system of any one of examples 50 to 54, wherein the opposite oblique directions of the partially enclosed shapes of the third cluster are 180 degrees apart.
Example 56 is the system of any one of examples 50 to 55, wherein the third cluster of contact pins is positioned along an axis defined by the first lateral direction and the second lateral direction.
Example 57 is the system of example 56, wherein the first subset and the second subset of the third cluster are positioned along the axis.
Example 58 is the system of example 56, wherein the first subset and the second subset of the third cluster are positioned along a second axis that is orthogonal to the axis.
Example 59 is the system of any one of examples 50 to 58, wherein the contact pins of the first subset are arranged in a first matrix region of the contact surface and the contact pins of the second subset are arranged in a second matrix region of the contact surface, wherein the first matrix region is adjacent to the second matrix region.
Example 60 is the system of any one of examples 50 to 59, wherein the contact pins of the first subset are interspersed with the contact pins of the second subset to form a common matrix region on the contact surface.
Example 61 is the system of example 60, wherein the contact pins of the first subset are interspersed randomly with the contact pins of the second subset.
Example 62 is the system of example 60, wherein the contact pins of the first subset are interspersed in a predetermined pattern with respect to the contact pins of the second subset.
Example 63 is the system of example 62, wherein the predetermined pattern alternates by rows or columns in the common matrix region.
Example 64 is the system of any one of examples 50 to 63, wherein a count of the contact pins in the first subset equals a count of the contact pins in the second subset.
Example 65 is the system of any one of examples 50 to 64, wherein the contact pins in the first subset and the second subset include a matrix of columns and rows of power pins, ground pins, and/or signal pins.
Example 66 is the system of example 65, wherein an outer perimeter of the matrix includes the ground pins.
Example 67 is the system of any one of examples 50 to 66, wherein adjacent contact pins of the first cluster and the second cluster are spaced apart with a first pitch, and adjacent contact pins of the third cluster are spaced apart with a second pitch that is different from the first pitch.
Example 68 is the system of example 67, wherein the second pitch is smaller than the first pitch.
Example 69 is the system of example 68, wherein the second pitch and the first pitch are horizontal pitches and/or vertical pitches.
Example 70 is the system of example 67, wherein the first and second pitches are in a same direction with respect to an axis defined by the first lateral direction and the second lateral direction.
Example 71 is the system of example 67, wherein the first pitch and the second pitch are in a direction orthogonal to an axis defined by the first lateral direction and the second lateral direction.
Example 72 is the system of any one of examples 50 to 71, wherein each of the first cluster and the second cluster together include 260 pins, wherein the third cluster includes 60 pins.
Example 73 is the system of any one of examples 50 to 72, wherein the oblique angle is configured to reduce far end crosstalk and/or near end cross talk between pins of the first, second, and third clusters.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A device comprising:
a first cluster of pins extending outward from a surface, each pin forming a partially enclosed shape that opens in a first direction along the surface;
a second cluster of pins extending outward from the surface, each pin forming a partially enclosed shape that opens in a second direction along the surface, wherein the second direction is opposite to the first lateral direction; and
a third cluster of pins positioned along the surface between the first cluster and the second cluster, wherein the pins of the third cluster comprise a first subset of pins and a second subset of pins, wherein each pin of the first subset form a partially enclosed shape that opens along a third direction that is oblique to the first and second directions, wherein each pin of the second subset form a partially enclosed shape that opens along a fourth direction that is opposite to the third direction.

2. The device of claim 1, wherein the partially enclosed shapes comprise C-shapes.

3. The device of claim 1, wherein the third direction is orthogonal to the first direction.

4. The device of claim 1, wherein the third cluster of pins is positioned along an axis defined by the first direction and the second direction.

5. The device of claim 3, wherein the first subset and second subset are positioned along a second axis that is orthogonal to the axis.

6. The device of claim 1, wherein the pins of the first subset are arranged in a first matrix region of the surface and the pins of the second subset are arranged in a second matrix region of the surface, wherein the first matrix region is adjacent to the second matrix region.

7. The device of claim 1, wherein the pins of the first subset are interspersed with the pins of the second subset to form a common matrix region on the surface.

8. The device of claim 7, wherein the pins of the first subset are interspersed randomly with the pins of the second subset.

9. The device of claim 7, wherein the pins of the first subset are interspersed a predetermined pattern with respect to the pins of the second subset.

10. The device of claim 9, wherein the predetermined pattern alternates by rows or columns in the common matrix region.

11. The device of claim 1, wherein the pins in the first subset and in the second subset comprise a matrix of columns and rows of power pins, ground pins, and/or signal pins.

12. The device of claim 11, wherein an outer perimeter of the matrix comprises the ground pins.

13. The device of claim 1, wherein adjacent pins of the first and second clusters are spaced apart with a first pitch, wherein adjacent pins of the third cluster are spaced apart with a second pitch that is different from the first pitch.

14. The device of claim 13, wherein the second pitch is smaller than the first pitch.

15. The device of claim 1, wherein the device comprises a compression mount connector for a memory module.

16. The device of claim 1, wherein the oblique angle is configured to reduce far end crosstalk and/or near end cross talk between pins of the first, second, and third clusters.

17. A computing device comprising:
a chassis having a mounting region configured to receive a memory module;
a compression mount connector secured to the mounting region, the compression mount connector comprising:
a first cluster of contact pins arranged on a first side of a contact surface of the compression mount connector, the contact pins forming partially enclosed shapes that open in a first lateral direction along the contact surface;
a second cluster of contact pins arranged on a second side of the contact surface opposite the first side, the contact pins forming partially enclosed shapes that open in a second lateral direction opposite to the first lateral direction; and
a third cluster of contact pins positioned between the first and second clusters, the third cluster comprising a first subset of pins and a second subset of pins, wherein each pin of the first and second subsets is a partially enclosed shape that opens in an oblique direction with respect to the first and second clusters, wherein the oblique direction of the first subset is opposite to the oblique direction of the second subset; and
a memory module configured to compressively engage with the compression mount connector, wherein the opposite oblique directions of the partially enclosed shapes of the third cluster are configured to counteract forces from compressive engagement between the memory module and the compression mount connector.

18. The computing device of claim 17, wherein the oblique direction of the partially enclosed shapes of the first subset is orthogonal to the first lateral direction.

19. A system comprising:
a memory module;
a compression mount connector configured to receive the memory module, the compression mount connector comprising:
a first cluster of contact pins arranged on a first side of a contact surface of the compression mount connector, the contact pins forming partially enclosed shapes that open in a first lateral direction along the contact surface;
a second cluster of contact pins arranged on a second side of the contact surface opposite the first side, the contact pins forming partially enclosed shapes that open in a second lateral direction opposite to the first lateral direction; and
a third cluster of contact pins positioned between the first and second clusters, the third cluster comprising a first subset of pins and a second subset of pins, wherein each pin of the first and second subsets is a partially enclosed shape that opens in an oblique direction with respect to the first and second clusters, wherein the oblique direction of the first subset is opposite to the oblique direction of the second subset; and
a memory module configured to compressively engage with the compression mount connector, wherein the opposite oblique directions of the partially enclosed shapes of the third cluster are configured to counteract forces from compressive engagement between the memory module and the compression mount connector.

20. The system of claim 19, wherein the contact pins of the first subset are arranged in a first matrix region of the contact surface and the contact pins of the second subset are arranged in a second matrix region of the contact surface, wherein the first matrix region is adjacent to the second matrix region.
